(19) United States
(12) Patent Application Publication
(10) Pub. No.: US 2008/0078593 A1
(43) Pub. Date: Apr. 3, 2008

(54) Hybrid Vehicle with Camless Valve Control

(76) Inventors: Walt Ortmann, Saline, MI (US); Philip Koneda, Novi, MI (US); Marvin Kraska, Dearborn, MI (US); Thomas Megli, Dearborn, MI (US)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/537,346

(22) Filed: Sep. 29, 2006

(51) Int. Cl. B60K 6/00

(52) U.S. Cl. 180/65.2; 903/941

(57) ABSTRACT

A method of controlling a hybrid propulsion system of a vehicle, where the hybrid propulsion system includes an internal combustion engine and an alternate torque source configured to provide motive power to the vehicle. While the engine is turned off, initial cranking of the engine is performed to initiate an engine start. During initial cranking, a cylinder valve is operated in a startup timing mode so as to reduce pumping work required to move a piston during initial cranking. Subsequent to initial cranking, the valve is operated with a different timing than that employed during the startup timing mode.

### BACKGROUND AND SUMMARY

Research and commercialization of vehicles with hybrid propulsion systems has increased substantially in recent years. Hybrid-electric vehicles (HEV) in particular have been successfully introduced into the marketplace, and are expected to capture substantial increases in market share in coming years. HEV vehicles may be configured in a variety of ways. Typical configurations include a battery or other energy storage device, and a motor/generator or other mechanism for converting mechanical energy of the vehicle into electrical energy stored in the battery, and/or for using the electrical energy stored in the battery to generate torque for propelling the vehicle.

HEV vehicles typically are capable of operating in different propulsion modes. For example, some HEV vehicles may be operated with the internal combustion engine turned on or turned off. In these vehicles, various control schemes are employed to control whether the engine is turned on or off, and to control transitions between modes.

There are various concerns associated with mode transitions in which the engine is turned on or turned off. To optimize fuel consumption, many hybrid vehicles turn off the internal combustion engine repeatedly during operation of the vehicle. In typical hybrid systems, turning the engine back on requires diverting some engine torque from vehicle propulsion to provide engine starting torque, including overcoming air compression in the cylinder. As this torque serves only to start the engine and does not aid in propelling the vehicle, it is a source of inefficiency. Compression and expansion of cylinder gasses can also produce unwanted torque and NVH phenomena during engine shutdown events, and can increase parasitic losses during electric-only operation.

The inventors have recognized these and other problems, and have addressed them by applying a camless valve control system and method to a hybrid vehicle. According to one example, the method includes performing propulsion mode changes in a hybrid propulsion system of a vehicle, where the hybrid propulsion system includes an internal combustion engine and an alternate torque source configured to provide motive power to the vehicle. The method includes, while the engine is turned off, initiating an initial cranking of the engine to perform an engine start. During initial cranking, a cylinder valve is operated in a startup timing mode so as to reduce pumping work required to move a piston during initial cranking. Subsequent to initial cranking, the valve is operated with a different timing than that employed during the startup timing mode. In another example, different propulsion modes are used when the engine is turned off and when the engine is turned on, and EVA valve actuation is used during propulsion mode transitions to achieve transitional valve control.

### DETAILED DESCRIPTION OF THE DRAWINGS

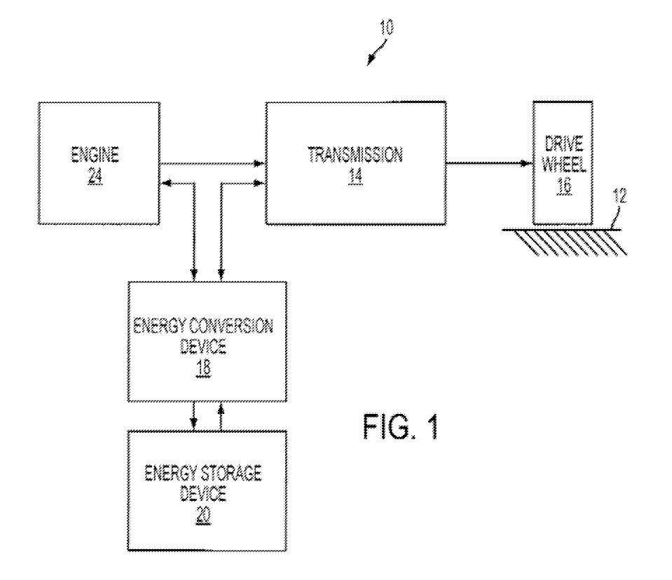

FIG. 1 is a schematic of a vehicle according to the present description;

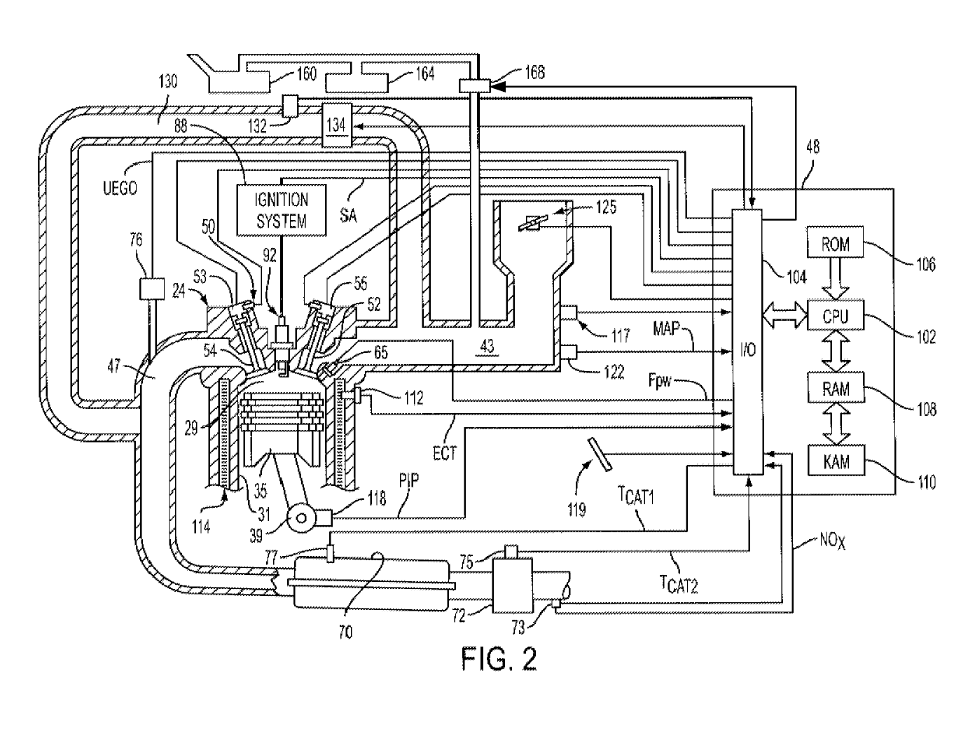

FIG. 2 is a schematic depiction of an internal combustion engine;

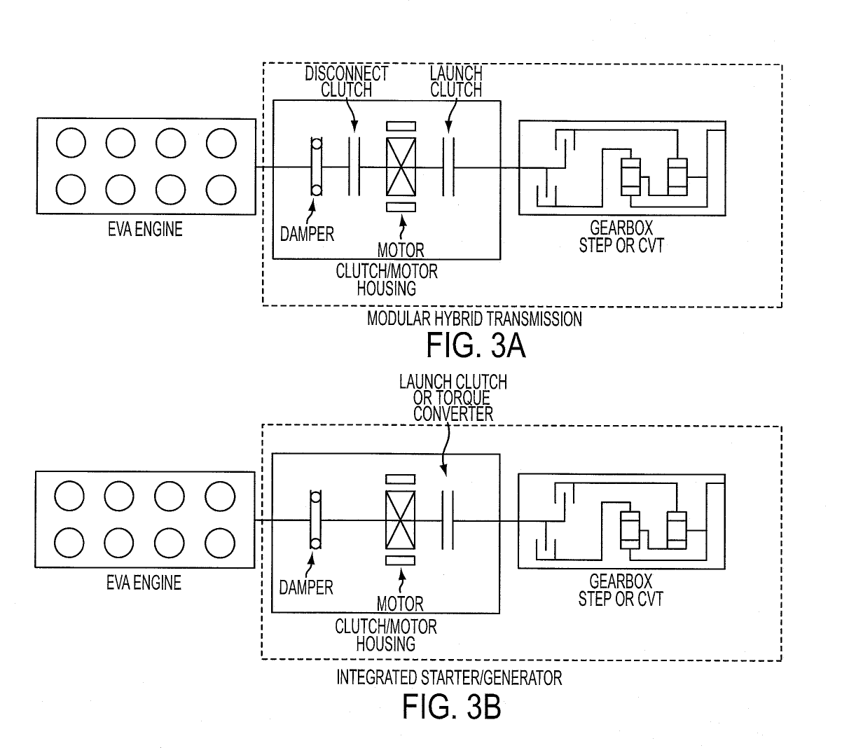

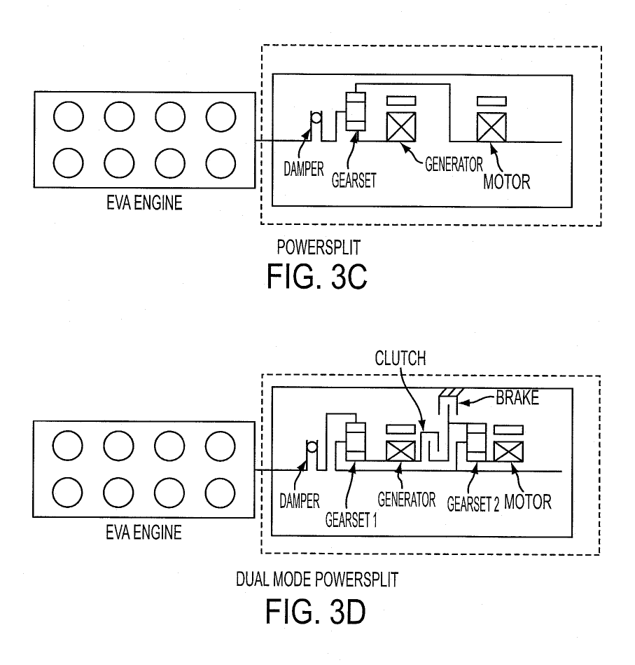

FIGS. 3A-3D are schematic depictions of exemplary hybrid powertrains according to the present description;

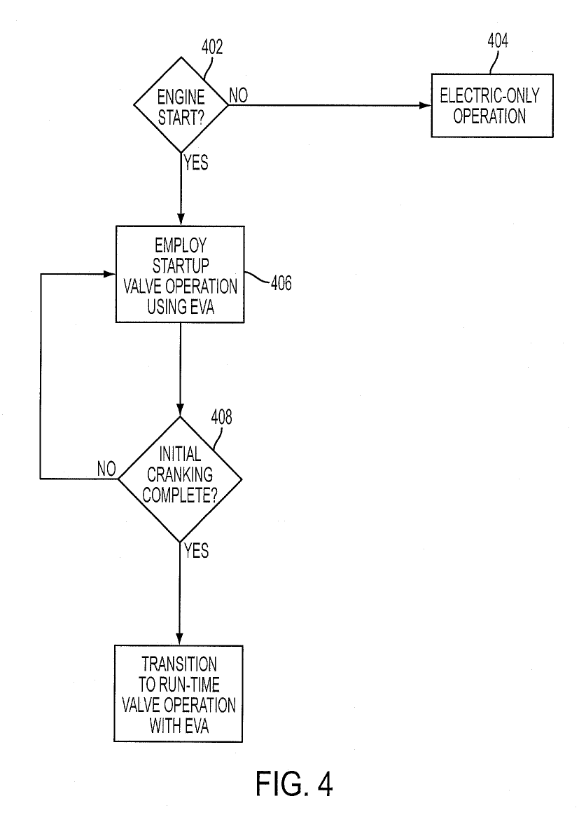

FIGS. 4-6 are flowcharts depicting exemplary methods for controlling and operating a hybrid powertrain using electrical valve actuation (EVA) within the internal combustion engine of the powertrain.

### DETAILED DESCRIPTION

Referring to FIG. 1, the figure schematically depicts a vehicle with a hybrid propulsion system 10. Hybrid propulsion system 10 includes an internal combustion engine 24, further described herein with particular reference to FIG. 2, coupled to transmission 14. Transmission 14 may be a manual transmission, automatic transmission, or combinations thereof. Further, various additional components may be included, such as a torque converter, and/or other gears such as a final drive unit, etc. Transmission 14 is shown coupled to drive wheel 16, which in turn is in contact with road surface 12.

In this example embodiment, the hybrid propulsion system also includes an energy conversion device 18, which may include a motor, a generator, among others and combinations thereof. The energy conversion device 18 is further shown coupled to an energy storage device 20, which may include a battery, a capacitor, a flywheel, a pressure vessel, etc. The energy conversion device can be operated to absorb energy from vehicle motion and/or the engine and convert the absorbed energy to an energy form suitable for storage by the energy storage device (i.e. provide a generator operation). The energy conversion device can also be operated to supply an output (power, work, torque, speed, etc.) to the drive wheels 16 and/or engine 24 (i.e. provide a motor operation). It should be appreciated that the energy conversion device may, in some embodiments, include only a motor, only a generator, or both a motor and generator, among various other components used for providing the appropriate conversion of energy between the energy storage device and the vehicle drive wheels and/or engine.

The depicted connections between engine 24, energy conversion device 18, transmission 14, and drive wheel 16 indicate transmission of mechanical energy from one component to another, whereas the connections between the energy conversion device and the energy storage device may indicate transmission of a variety of energy forms such as electrical, mechanical, etc. For example, torque may be transmitted from engine 24 to drive the vehicle drive wheels 16 via transmission 14. As described above energy storage device 18 may be configured to operate in a generator mode and/or a motor mode. In a generator mode, system 18 absorbs some or all of the output from engine 24 and/or transmission 14, which reduces the amount of drive output delivered to the drive wheel 16, or the amount of braking torque to the drive wheel 16. Such operation may be employed, for example, to achieve efficiency gains through regenerative braking, improved engine efficiency, etc. Further, the output received by the energy conversion device may be used to charge energy storage device 20. In motor mode, the energy conversion device may supply mechanical output to engine 24 and/or transmission 14, for example by using electrical energy stored in an electric battery.

Hybrid propulsion embodiments may include full hybrid systems, in which the vehicle can run on just the engine, just the energy conversion device (e.g. motor), or a combination of both. Assist or mild hybrid configurations may also be employed, in which the engine is the primary torque source, with the hybrid propulsion system acting to selectively deliver added torque, for example during tip-in or other conditions. Further still, starter/generator and/or smart alternator systems may also be used. The various components described above with reference to FIG. 1 may be controlled by a vehicle controller as will be describe below with reference to FIG. 2.

From the above, it should be understood that the exemplary hybrid propulsion system is capable of various modes of operation. In a full hybrid implementation, for example, the propulsion system may operate using energy conversion device 18 (e.g., an electric motor) as the only torque source propelling the vehicle. This “electric only” mode of operation may be employed during braking, low speeds, while stopped at traffic lights, etc. In another mode, engine 24 is turned on, and acts as the only torque source powering drive wheel 16. In still another mode, which may be referred to as an “assist” mode, the alternate torque source 18 may supplement and act in cooperation with the torque provided by engine 24. As indicated above, energy conversion device 18 may also operate in a generator mode, in which torque is absorbed from engine 24 and/or transmission 14. Furthermore, energy conversion device 18 may act to augment or absorb torque during transitions of engine 24 between different combustion modes (e.g., during transitions between a spark ignition mode and a compression ignition mode).

FIG. 2 shows one cylinder of a multi-cylinder engine, as well as the intake and exhaust path connected to that cylinder. Internal combustion engine 24 is shown in FIG. 2 as a direct injection gasoline engine with a spark plug; however, engine 24 may utilize port injection exclusively or in conjunction with direct injection. In an alternative embodiment, a port fuel injection configuration may be used where a fuel injector is coupled to intake manifold 43 in a port, rather than directly to combustion chamber 29.

Engine 24 includes combustion chamber 29 and cylinder walls 31 with piston 35 positioned therein and connected to crankshaft 39. Combustion chamber 29 is shown communicating with intake manifold 43 and exhaust manifold 47 via respective intake valve 52 and exhaust valve 54. While only one intake and one exhaust valve are shown, the engine may be configured with a plurality of intake and/or exhaust valves. FIG. 2 merely shows one cylinder of a multi-cylinder engine, and that each cylinder has its own set of intake/exhaust valves, fuel injectors, spark plugs, etc.

In some embodiments, intake valve 52 and exhaust valve 54 may be controlled by electric valve actuators (EVA) 55 and 53, respectively. Valve position sensors 50 may be used to determine the position of the valves such as for example, fully opened, fully closed, or another position in between.

In some embodiments, combustion cylinder 29 can be deactivated by at least stopping the supply of fuel supplied to combustion cylinder 29 for at least one cycle. During deactivation of combustion cylinder 29, one or more of the intake and exhaust valves can be adjusted to control the amount of air passing through the cylinder. In this manner, engine 24 can be configured to deactivate one, some or all of the combustion cylinders, thereby enabling variable displacement engine (VDE) operation.

Engine 24 is further shown configured with an exhaust gas recirculation (EGR) system configured to supply exhaust gas to intake manifold 43 from exhaust manifold 47 via EGR passage 130. The amount of exhaust gas supplied by the EGR system can be controlled by EGR valve 134. Further, the exhaust gas within EGR passage 130 may be monitored by an EGR sensor 132, which can be configured to measure temperature, pressure, gas concentration, etc. Under some conditions, the EGR system may be used to regulate the temperature of the air and fuel mixture within the combustion chamber, thus providing a method of controlling the timing of combustion by autoignition.

Engine 24 is also shown having fuel injector 65 coupled thereto for delivering liquid fuel in proportion to the pulse width of signal FPW from controller 48 directly to combustion chamber 29. As shown, the engine may be configured such that the fuel is injected directly into the engine cylinder, which is known to those skilled in the art as direct injection. Distributorless ignition system 88 provides ignition spark to combustion chamber 29 via spark plug 92 in response to controller 48. Universal Exhaust Gas Oxygen (UEGO) sensor 76 is shown coupled to exhaust manifold 47 upstream of catalytic converter 70. The signal from sensor 76 can be used to advantage during feedback air/fuel control in a conventional manner to maintain average air/fuel at stoichiometry during the stoichiometric homogeneous mode of operation.

FIG. 2 further shows engine 24 configured with an aftertreatment system comprising a catalytic converter 70 and a lean NOx trap 72. In this particular example, temperature Tcat1 of catalytic converter 70 is measured by temperature sensor 77 and temperature Tcat2 of lean NOx trap 72 is measured by temperature sensor 75. Further, gas sensor 73 is shown arranged in exhaust passage 47 downstream of lean NOx trap 72, wherein gas sensor 73 can be configured to measure the concentration of NOx and/or O₂ in the exhaust gas.

In some embodiments, the engine may include a fuel vapor purging system for purging fuel vapors to the combustion chamber. As one example, fuel vapors originating in fuel tank 160 may be stored in fuel vapor storage tank 164 until they are purged to intake passage 43 via fuel purge valve 168. Fuel vapor purge valve 168 may be connected to controller 48. Furthermore, the position of the fuel vapor purge valve may be varied by the control system to provide fuel vapors to the combustion chamber during select operating conditions.

Controller 48 is shown in FIG. 2 as a conventional microcomputer including: microprocessor unit 102, input/output ports 104, and read-only memory 106, random access memory 108, keep alive memory 110, and a conventional data bus. Controller 48 is shown receiving various signals from sensors coupled to engine 24, in addition to those signals previously discussed, including: engine coolant temperature (ECT) from temperature sensor 112 coupled to cooling sleeve 114; a pedal position sensor 119 coupled to an accelerator pedal; a measurement of engine manifold pressure (MAP) from pressure sensor 122 coupled to intake manifold 43; a measurement (ACT) of engine air charge temperature or manifold temperature from temperature sensor 117; and an engine position sensor from a Hall effect sensor 118 sensing crankshaft 39 position. In some embodiments, the requested wheel output can be determined by pedal position, vehicle speed, and/or engine operating conditions, etc. In one aspect of the present description, engine position sensor 118 produces a predetermined number of equally spaced pulses every revolution of the crankshaft from which engine speed (RPM) can be determined.

In some embodiments, controller 48 can be configured to control operation of the various systems described above with reference to FIG. 1. For example, the energy storage device may be configured with a sensor that communicates with controller 48, thereby enabling a determination to be made of the state of charge or quantity of energy stored by the energy storage device. In another example, controller 48 or other controller can be used to vary a condition of the energy conversion device and/or transmission. Further, in some embodiments, controller 48 may be configured to cause combustion chamber 29 to operate in various combustion modes, as described herein. The fuel injection timing may be varied to provide different combustion modes, along with other parameters, such as EGR, valve timing, valve operation, valve deactivation, etc.

Combustion in engine 10 can be of various types/modes, depending on operating conditions. In one example, spark ignition (SI) can be employed where the engine utilizes a sparking device, such as spark plug coupled in the combustion chamber, to regulate the timing of combustion chamber gas at a predetermined time after top dead center of the expansion stroke. In one example, during spark ignition operation, the temperature of the air entering the combustion chamber is considerably lower than the temperature required for autoignition. While SI combustion may be utilized across a broad range of engine torque and speed it may produce increased levels of NOx and lower fuel efficiency when compared with other types of combustion.

Another type of combustion that may be employed by engine 10 uses homogeneous charge compression ignition (HCCI), or controlled autoignition (CAI), where autoignition of combustion chamber gases occurs at a predetermined point after the compression stroke of the combustion cycle, or near top dead center of compression. Typically, when compression ignition of a pre-mixed air and fuel charge is utilized, fuel is normally homogeneously premixed with air, as in a port injected spark-ignited engine or direct injected fuel during an intake stroke, but with a high proportion of air to fuel. Since the air/fuel mixture is highly diluted by air or residual exhaust gases, which results in lower peak combustion gas temperatures, the production of NOx may be reduced compared to levels found in SI combustion. Furthermore, fuel efficiency while operating in a compression combustion mode may be increased by reducing the engine pumping loss, increasing the gas specific heat ratio, and by utilizing a higher compression ratio.

In compression ignition operation mode, it may be desirable to exercise close control over the timing of autoignition. The initial intake charge temperature directly affects the timing of autoignition. The start of ignition is not directly controlled by an event such as the injection of fuel in the standard diesel engine or the sparking of the spark plug in the spark ignited engine. Furthermore, the heat release rate is not controlled by either the rate or duration of the fuel-injection process, as in the diesel engine, or by the turbulent flame propagation time, as in the spark-ignited engine.

Note that autoignition is also a phenomenon that may cause knock in a spark-ignited engine. Knock may be undesirable in spark-ignited engines because it enhances heat transfer within the cylinder and may burn or damage the piston. In controlled compression ignition operation, with its high air-to-fuel ratio, knock does not generally cause degradation of the engine because the diluted charge keeps the rate of pressure rise low and the maximum temperature of the burned gases relatively low. The lower rate of pressure rise mitigates the damaging pressure oscillations characteristic of spark ignition knock.

In comparison to a spark ignition engine, the temperature of the charge at the beginning of the compression stroke typically may be increased to reach autoignition conditions at or near the end of the compression stroke. It will be appreciated by those skilled in the art that numerous other methods may be used to elevate initial charge temperature. Some of these include: heating the intake air (heat exchanger), keeping part of the warm combustion products in the cylinder (internal EGR) by adjusting intake and/or exhaust valve timing, compressing the inlet charge (turbo-charging and supercharging), changing the autoignition characteristics of the fuel provided to the engine, and heating the intake air charge (external EGR).

During HCCI combustion, autoignition of the combustion chamber gas may be controlled to occur at a desired position of the piston or crank angle to generate desired engine torque, and thus it may not be necessary to initiate a spark from a sparking mechanism to achieve combustion. However, a late timing of the spark plug, after an autoignition temperature should have been attained, may be utilized as a backup ignition source in the case that autoignition does not occur.

Note that a plurality of other parameters may affect both the peak combustion temperature and the required temperature for efficient HCCI combustion. These and any other applicable parameters may be accounted for in the routines embedded in engine controller 48 and may be used to determine optimum operating conditions. For example, as the octane rating of the fuel increases, the required peak compression temperature may increase as the fuel requires a higher peak compression temperature to achieve ignition. Also, the level of charge dilution may be affected by a variety of factors including both humidity and the amount of exhaust gases present in the intake charge. In this way, it is possible to adjust engine parameters to compensate for the effect of humidity variation on autoignition, i.e., the effect of water makes autoignition less likely.

In one particular example, autoignition operation and combustion timing may be controlled by varying intake and/or exhaust valve timing and/or lift to, for example, adjust the amount of residual trapped gasses. Operating an engine in HCCI using the gas trapping method can provide fuel-efficient combustion with extremely low engine out NOx emissions.

However, the achievable HCCI window of operation for low engine speed and/or low engine load may be limited. That is, if the temperature of the trapped gas is too low, then HCCI combustion may not be possible at the next combustion event. If it is necessary to switch out of HCCI and into spark ignition mode during low load in which temperatures may fall too low, and then to return back into HCCI operation once conditions are acceptable, there may be penalties in engine emissions and fuel economy and possible torque/NVH disruption to the driver during each transition. Therefore, in one embodiment, a method that enables additional operation in HCCI or other limited combustion mode at high or low speeds and loads is described herein utilizing an alternative torque source, such as an energy conversion device/generator. Furthermore, extending the low load limit of HCCI operation, for one or more cycles, to obtain increased benefit from HCCI operation may be desirable.

While one or more of the above combustion modes may be used in some examples, still other combustion modes may be used, such as stratified operation, either with or without spark initiated combustion.

As discussed above, hybrid propulsion system 10 may be operated in a variety of different modes. Various inputs may be used to select from among the different modes, and/or to control operation of the hybrid propulsion system while operating in a given mode. Example inputs include engine speed, vehicle speed, requested torque, catalyst temperature, manifold pressure, air/fuel ratio, catalyst temperature and/or status of aftertreatment systems, throttle position, accelerator pedal position, requested power, adaptively-learned drive behavior, operating temperature conditions, humidity, etc., status of climate controls, PIP, state of charge (SOC) in hybrid-electric vehicle, etc.

Also, it should be understood that the hybrid drivetrain may be configured in a variety of different ways. FIGS. 3A, 3B, 3C and 3D schematically depict exemplary hybrid drivetrains that may be employed in connection with the systems and methods disclosed herein.

In the various exemplary systems and methods, it will often be desirable to employ camless valve control over the internal combustion engine. Electro-hydraulic, electromechanical and/or other electrically-actuated camless valve control systems may be employed. In these electrically-actuated camless systems (referred to generally herein as EVA systems), cylinder valve operation is not constrained mechanically by the position of the engine crankshaft. Accordingly, a variety of different valve modes may be employed, including timing/lift variations, in order to achieve various benefits during operation of the hybrid powertrain. EVA control may be employed during mode transitions when the engine is being turned on or off, and/or may be employed within various operating modes (e.g., electric-only operation), to improve fuel consumption, reduce NVH, optimize aftertreatment performance and provide other benefit.

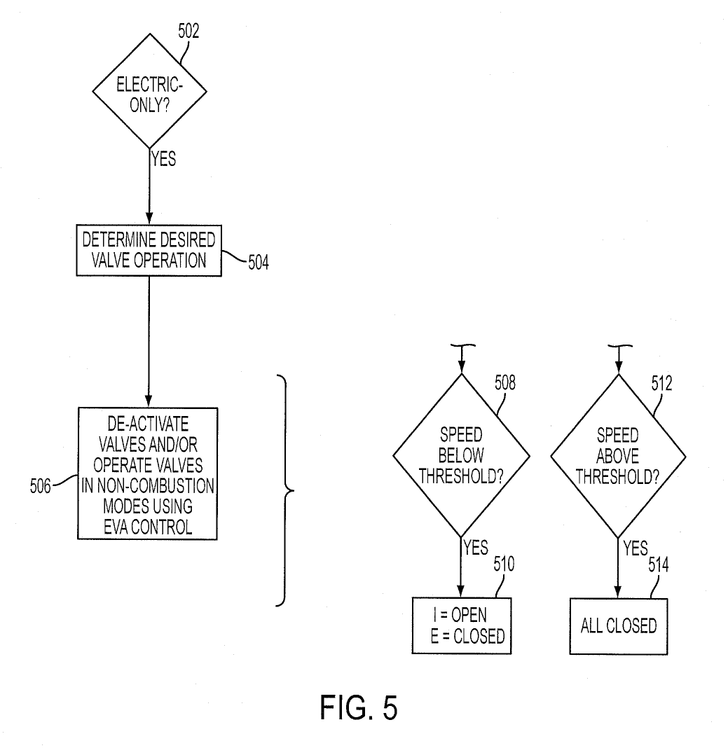

Referring now to FIG. 4 an exemplary method of employing EVA control in a hybrid powertrain will be described, in the context of an engine start event. As known in the art, many hybrid propulsion systems shut down the engine during times of low engine efficiency, such as during idle. When the driver demands acceleration by depressing the accelerator pedal or releasing the brake, it is normally desirable that the engine be restarted in a quick and seamless manner. During the initial engine crank, a significant amount of torque is needed to overcome the compression of air in the cylinder. EVA control can be employed to reduce the torque needed to start the engine. At 402, the method includes detecting an engine start request. In the absence of such a request, the propulsion system continues at 404 to operate without the engine (e.g., in electric-only mode). As discussed below with reference to FIG. 5, EVA valve control may be employed to optimize operation during electric-only operating modes. In this and certain other examples discussed herein, the hybrid powertrains include electric motors as the alternate torque source. It should be understood, however, that the EVA control systems and methods discussed herein are equally applicable to other hybrid configurations, and should not be construed as limited to hybrid-electric applications.

Continuing with FIG. 4, at 406 and 408, the vehicle EVA control system causes one or more cylinder valves to operate in a startup mode during initial cranking of the engine. For example, one or more valves may be held open to allow air to move freely into and out of the cylinder. According to one example, the intake valves are held open while the exhaust valves are closed. This removes the compression torque while preventing unwanted flow of air to the engine aftertreatment system. After the initial cranking, once the engine begins to turn, the valves may be transitioned into run-time operation, as shown at 410.

Referring now to FIG. 5, EVA valve control may also be advantageously employed in hybrid configurations where the non-engine propulsion system causes the engine to turn. For example, in integrated started-generator (ISG) configurations, the motor is not disconnected from the engine. Accordingly, the engine must turn with the motor during electric-only operating modes. This circumstance can increase parasitic losses and undermine the benefits of regenerative braking. EVA control may be employed in electric-only modes to counter these effects and provide other benefits.

Referring specifically to the figure, during electric-only mode (determination at 502), the method may include determining at 504 whether EVA control can be employed to achieve one or more net benefits. For example, while on one hand there may be a benefit to actively opening and closing cylinder valves during electric-only mode, at times it may be desirable to deactivate one or more cylinders, as shown at 506, to reduce the electrical load of the EVA valvetrain. Deactivation may be implemented in various different ways. Engine speed may be used as a factor to control EVA valve deactivation. For example, the deactivation at 506 may be implemented by holding intake valves open and exhaust valves closed at low engine speeds, or if engine speed is below a threshold, as shown at 508 and 510. This closing of the valves can minimize pumping losses in addition to lowering the electrical load on the EVA system. Additionally, or alternatively, all valves may be closed at high(er) speeds, as shown at 512 and 514. Such opening of the valves at low speeds may aid in reducing blow-by and heat transfer losses resulting from compression/recompression of the cylinder gases. Accordingly, holding all the valves closed through EVA actuation may be the most desirable operating mode to reduce friction at higher engine speeds.

EVA actuation may also be employed during mode transitions involving engine shutdown. Typically, as the engine comes to rest, torsional pulses are caused by the piston compressing and expanding air that is trapped in the cylinder. These pulses can be mitigated to the driveline through slipping of clutches or motor control, however there is little opportunity to mitigate pulse transmission to the vehicle body. Accordingly, engine shutdown events can produce degraded noise, vibration and harshness (NVH), also referred to as shutdown shake, a problem exacerbated in hybrid systems by the fact that the engine is often turned on and off repeatedly during operation of the vehicle.

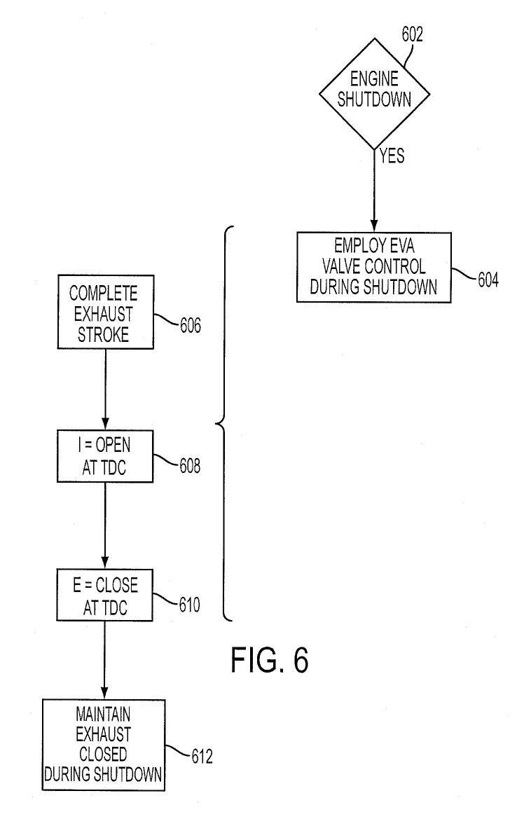

Accordingly, the present disclosure provides a system and method for employing EVA valve control in a hybrid vehicle during engine shutdown events. An exemplary method is depicted in FIG. 6. At 602, the method includes detecting initiation of engine shutdown. Then, at 604, EVA control is used to reduce or eliminate the above-described torsionals and thereby provide a smoother shutdown event. Typically, this involves using a shutdown mode of valve operation different from that employed during normal firing and operation of the engine. 606-612 depict an exemplary EVA control of valve operation during a shutdown event. At 606, the exhaust stroke is completed. At 608, the intake valve is opened at TDC, and the exhaust valve is closed (610). In addition to reducing NVH in many settings, the above example reduces or eliminates unwanted airflow to catalysts during engine shutdown, and thus eliminates or reduces the need for purging enrichment during engine restart.

Note that the example control and estimation routines included herein can be used with various engine and/or hybrid propulsion system configurations. The specific routines described herein may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into the computer readable storage medium in controller 48.

It will be appreciated that the configurations and routines disclosed herein are exemplary in nature, and that these specific embodiments are not to be considered in a limiting sense, because numerous variations are possible. For example, the above technology can be applied to V-4, V-6, V-8, I-4, I-6, V-10, V-12, opposed 4, and other engine types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A method of performing propulsion mode changes in a hybrid propulsion system of a vehicle, where the hybrid propulsion system includes an internal combustion engine and an alternate torque source configured to provide motive power to the vehicle, the method comprising:
while the engine is turned off, initiating initial cranking of the engine to perform an engine start;
during initial cranking of the engine, operating a valve of at least one cylinder of the engine in a startup timing mode so as to reduce pumping work required to move a piston within the cylinder during initial cranking; and
subsequent to initial cranking of the engine, operating the valve with a different timing than that employed during the startup timing mode.

2. A hybrid propulsion system for a vehicle, comprising:
an internal combustion engine including a plurality of combustion cylinders having electrically-actuated cylinder valves; and
an electric motor configured to provide motive force to propel the vehicle when the internal combustion engine is turned off,
where the hybrid propulsion system is configured to operate in a first propulsion mode in which the internal combustion engine is turned off and the electric motor propels the vehicle, and in a second propulsion mode in which the internal combustion engine is turned off.

3. The system of claim 2, where when the system is operated in the first propulsion mode, operation of the electric motor causes rotation of a crankshaft of the internal combustion engine, thereby resulting in reciprocation of one or more pistons of the internal combustion engine.

4. The system of claim 3, where the system is configured so that, during at least a portion electric-only operation, one or more cylinders of the internal combustion engine are deactivated by being held open or being held closed.

5. The system of claim 4, where the system is configured so that, during at least a portion of electric-only operation, at least one intake cylinder valve is held open and at least one exhaust cylinder valve is held closed.

6. The system of claim 4, where the system is configured so that, during at least a portion of electric-only operation, all cylinder valves of the internal combustion engine are held closed.

7. The system of claim 2, where the system is configured so that, during a propulsion mode transition in which the engine is shut down, one or more of the electrically-actuated valves are held open while the engine is shutting down.

8. The system of claim 2, where the system is configured so that, during a propulsion mode transition in which the engine is shut down, one or more of the electrically-actuated valves are held closed while the engine is shutting down.

9. The system of claim 2, where the system is configured so that, during a propulsion mode transition in which the engine is turned on, one or more of the electrically-actuated valves are held open during initial cranking of the engine.

10. A method of performing propulsion mode changes in a hybrid propulsion system of a vehicle, where the hybrid propulsion system includes an internal combustion engine and an alternate torque source configured to provide motive power to the vehicle, the method comprising:
operating the vehicle in a first propulsion mode in which the engine is turned off;
operating the vehicle in a second propulsion mode in which the engine is turned on; and
during transition from one of the propulsion modes to the other of the propulsion modes, operating a valve of at least one cylinder of the engine in a transitional mode so as to reduce compression work required to move a piston within the cylinder during the transition.

11. The method of claim 10, where operating the valve in the transitional mode includes employing a different timing for the valve than that used for the valve during the second propulsion mode.

12. A method of controlling a hybrid propulsion system of a vehicle, where the hybrid propulsion system includes an internal combustion engine and an alternate torque source configured to provide motive power to the vehicle, the method comprising:
operating the vehicle in a first propulsion mode in which the engine is turned off and the alternate torque source propels the vehicle;
operating the vehicle in a second propulsion mode in which the engine is turned on; and
electrically actuating a camless valve system of the internal combustion engine.

13. The method of claim 12, where the alternate torque source is an electric motor.

14. The method of claim 13, where when the vehicle is operated in the first propulsion mode, operation of the alternate torque source causes rotation of a crankshaft of the internal combustion engine, thereby resulting in reciprocation of one or more pistons of the internal combustion engine.

15. The method of claim 14, where electrically actuating the camless valve system includes, during the first propulsion mode, deactivating at least one cylinder valve of the internal combustion engine.

16. The method of claim 15, where electrically actuating the camless valve system includes, during the first propulsion mode, holding at least one intake cylinder valve open and at least one exhaust cylinder valve closed for multiple rotations of the internal combustion engine.

17. The method of claim 15, where electrically actuating the camless valve system includes, during the first propulsion mode, holding all cylinder valves of the internal combustion engine closed for multiple rotations of the internal combustion engine.

18. The method of claim 13, further comprising, during a transition from the second propulsion mode to the first propulsion mode, electrically actuating the camless valve system so that one or more cylinder valves of the internal combustion engine are held open while the engine is shutting down.

19. The method of claim 13, further comprising, during a transition from the second propulsion mode to the first propulsion mode, electrically actuating the camless valve system so that one or more exhaust cylinder valves of the internal combustion engine are held closed while the engine is shutting down.

20. The method of claim 13, further comprising, during a transition from the second propulsion mode to the first propulsion mode, (a) completing an exhaust stroke of a piston of the internal combustion engine; (b) opening an intake cylinder valve associated with the piston as the piston substantially reaches top dead center and maintaining the intake cylinder valve open as the piston continues to reciprocate; and (c) closing an exhaust cylinder valve associated with the piston as the piston substantially reaches top dead center and maintaining the exhaust cylinder valve closed as the piston continues to reciprocate.

21. The method of claim 13, further comprising, during a transition from the first propulsion mode to the second propulsion mode, electrically actuating the camless valve system so that one or more cylinder valves of the internal combustion engine are held open while the engine is starting up.

22. The method of claim 13, further comprising, during a transition from the first propulsion mode to the second propulsion mode, electrically actuating the camless valve system so that one or more cylinder valves of the internal combustion engine are operated in a transitional mode while the engine is starting up.

23. The method of claim 22, where after the engine has started up, the one or more cylinder valves are operated with a timing that is different from that employed during the transitional mode.
